(19) United States
(12) Patent Application Publication
(10) Pub. No.: US 2024/0115071 A1
(43) Pub. Date: Apr. 11, 2024

(54) CONTAINER SUPPLY DEVICE

(71) Applicant: TECHMAGIC INC., Tokyo (JP)

(72) Inventors: Toshiyuki TAKADA, Tokyo (JP); Shunsuke INAI, Tokyo (JP)

(21) Appl. No.: 18/510,661

(22) Filed: Nov. 16, 2023

Related U.S. Application Data
(63) Continuation of application No. PCT/JP2022/016248, filed on Mar. 30, 2022.

(30) Foreign Application Priority Data
Jul. 8, 2021 (JP) 2021-113844

(51) Int. Cl. A47J 31/44; B67D 1/08

(52) U.S. Cl. CPC A47J 31/4425; A47J 31/4414; B67D 1/0894; B67D 2210/00076

(57) ABSTRACT

To provide a container supply device which is capable of improving accommodation efficiency of containers and simplifying accommodation work. The container supply device includes: a transfer mechanism which transfers the containers a feed position opposing a feed port of the containers of the container storage; and a feed mechanism which sequentially feeds the containers having been transferred to the feed position by the transfer mechanism toward the supply position through the feed port, wherein the transfer mechanism includes: one or more container mounting lane unit in which the containers are arranged so as to be movable in a column direction, the container mounting lane unit being arranged so as to be lined up in a row direction intersecting the column direction; and a lane transfer unit which moves the container mounting lane unit in the row direction and transfers the containers on a side of the feed port mounted on the container mounting lane unit to the feed position.

### RELATED APPLICATIONS

The present application is a continuation application of International Application No. PCT/JP2022/016248 filed Mar. 30, 2022, which claims priority to Japanese Application No. 2021-113844, filed Jul. 8, 2021, the disclosures of which applications are hereby incorporated by reference herein in their entirety.

### TECHNICAL FIELD

The present invention relates to a container supply device which supplies containers.

### BACKGROUND ART

Recently, against the backdrop of shortages of employees and the like at restaurants, there is a need of the restaurants to automate a service process. In accordance with such needs, systems that automatically provide food and beverages at restaurants are being proposed.

For example, PTL 1 describes an automatic beverage provision system which includes means for accepting an order by a customer, means for preparing a beverage and pouring the beverage into a container, and means for providing the customer with the beverage having been poured into the container.

The automatic beverage provision system described above includes a container storage which stores containers for beverages so that the containers reach a predetermined temperature and, in accordance with an order placed by the customer, pours a beverage into one of the containers retrieved from the container storage and provides the beverage having been poured into the container.

### CITATION LIST

### Patent Literature

[PTL 1] Japanese Patent Application Publication No. 2020-117314

### SUMMARY OF INVENTION

### Technical Problem

The automatic beverage provision system according to PTL 1 is structured such that the container storage stores containers along a spiral container conveyance path and vessels are sequentially retrieved from a container takeout port provided in a lowermost part of the container conveyance path. However, since the container storage has a spiral structure, accommodation efficiency is low and, at the same time, since accommodating containers in the container storage requires feeding one container at a time to a container feeding port provided in an uppermost part of the container conveyance path, there is a problem of low work efficiency when replenishing the containers.

In consideration thereof, an object of the present invention is to provide a container supply device which is capable of improving accommodation efficiency of containers and improving work efficiency of accommodating containers and which enables containers to be readily sequentially retrieved.

### Solution to Problem

The above object of the present invention can be achieved by the following configurations. A container supply device which supplies containers to a supply position from a container storage where the containers are stored, the container supply device comprising:
a transfer mechanism which transfers the containers to a feed position opposing a feed port of the containers of the container storage; and a feed mechanism which sequentially feeds the containers having been transferred to the feed position by the transfer mechanism toward the supply position through the feed port, wherein
the transfer mechanism includes:
one or more container mounting lane unit in which the containers are arranged so as to be movable in a column direction, the container mounting lane unit being arranged so as to be lined up in a row direction intersecting the column direction; and
a lane transfer unit which moves the container mounting lane unit in the row direction and transfers the containers on a side of the feed port mounted on the container mounting lane unit to the feed position.

A container supply device according to a second aspect of the present invention is the container supply device according to the first aspect, wherein
the transfer mechanism includes a lane mounting tray unit which is moved in the row direction by the lane transfer unit, and
the container mounting lane unit is mounted on the lane mounting tray unit with a side of the feed port inclined downward.

A container supply device according to a third aspect of the present invention is the container supply device according to the second aspect, wherein
the feed mechanism includes a stopper unit which protrudes in the row direction in a top view, and
the stopper unit is provided so as to freely penetrate between a container to be a side of the feed port and a container adjacent to the rear of the container to be a side of the feed port due to a movement of the container mounting lane unit in the row direction by the lane transfer unit.

A container supply device according to a fourth aspect of the present invention is the container supply device according to the third aspect, wherein the stopper unit has a curved shape in which a front end part faces the side of the feed port with respect to the row direction in a top view.

A container supply device according to a fifth aspect of the present invention is the container supply device according to the third aspect, wherein the feed mechanism includes an abutting member which is movable in the column direction at a position behind a front end position in the row direction of the stopper unit, and the abutting member abuts the container and propels the container to the feed port.

A container supply device according to a sixth aspect of the present invention is the container supply device according to the first aspect, wherein
the containers are arranged by being lined up so as to be movable in a column direction in the container mounting lane unit.

A container supply device according to a seventh aspect of the present invention is the container supply device according to the first aspect, further comprising:
a container detecting unit which detects the containers arranged in the container mounting lane unit; and
a controller which controls a transport actuator of the lane transfer unit in accordance with a detection signal of the container detecting unit.

### Advantageous Effects of Invention

According to the first aspect of the present invention, due to a container supply device which supplies containers to a supply position from a container storage where the containers are stored including: a transfer mechanism which transfers the containers to a feed position opposing a feed port of the containers of the container storage; and a feed mechanism which sequentially feeds the containers having been transferred to the feed position by the transfer mechanism toward the supply position through the feed port, the transfer mechanism including: a plurality of container mounting lane units in which the containers are arranged by being lined up so as to be movable in a column direction, the plurality of container mounting lane units being arranged so as to be lined up in a row direction intersecting the column direction; and a lane transfer unit which moves the plurality of container mounting lane units in the row direction and transfers the containers on a side of the feed port mounted on the container mounting lane units to the feed position, since the containers are arranged in a matrix pattern by being lined up and arranged on the plurality of container mounting lane units and the containers arranged in the matrix pattern are sequentially fed from the container storage toward the supply position by the transfer mechanism and the feed mechanism, the plurality of containers can be accommodated with high accommodation efficiency in the matrix pattern, and since withdrawing the plurality of container mounting lane units from the container storage to outside enables work efficiency of accommodating the containers to be improved, accommodation efficiency of the containers can be improved and work efficiency of accommodating the containers can be improved and, consequently, the containers can be readily sequentially extracted.

According to the container supply device of the second aspect of the present invention, in addition to the effect produced by the container supply device according to the first aspect of the present invention, due to the transfer mechanism including a lane mounting tray unit which is moved in the row direction by the lane transfer unit and the container mounting lane units being mounted on the lane mounting tray unit with a side of the feed port inclined downward, since the containers are moved in the direction of the side of the feed port using their own weight and the plurality of container mounting lane units are collectively moved in the row direction due to the movement of the lane mounting tray unit in the row direction, a drive mechanism of the transfer mechanism can be omitted.

According to the container supply device of the third aspect of the present invention, in addition to the effect produced by the container supply device according to the second aspect of the present invention, due to the feed mechanism including a stopper unit which protrudes in the row direction in a top view and the stopper unit being provided so as to freely penetrate between a container at a head of a column to be a side of the feed port and a container adjacent to the rear of the container at the head of the column due to a movement of the container mounting lane units in the row direction by the lane transfer unit, since the stopper unit being fixed is inserted between the container at a head position of a column to be a side of the feed port and a container adjacent to the rear of the container at the head position and a movement of the rear container in the incline direction is blocked when the lane mounting tray unit is moved in the row direction, even when the containers are closely arranged in the column direction, the container at the head of a column to be a side of the feed port can be sequentially fed separately from subsequent containers, and since the stopper unit can be fixed, a drive mechanism for a stopper is not required.

According to the container supply device of the fourth aspect of the present invention, in addition to the effect produced by the container supply device according to the third aspect of the present invention, due to the stopper unit having a curved shape in which a front end part faces the side of the feed port with respect to the row direction in a top view, since the container adjacent to the rear having abutted the front end of the stopper unit is smoothly moved along the shape of the stopper unit so as to increase a distance to the container at the head position of the column due to a movement of the lane mounting tray unit in the row direction, even when the containers are closely arranged in the column direction, the containers can be readily fed to the side of the feed port.

According to the container supply device of the fifth aspect of the present invention, in addition to the effect produced by the container supply device according to the third aspect of the present invention, due to the feed mechanism including an abutting member which is movable in the column direction at a position behind a front end position in the row direction of the stopper unit and the abutting member abutting the container and propelling the container to the feed port, since containers are abutted by the abutting member and propelled to the feed port in a state where the container at a head position of the column to be an earlier feed object and a subsequent container are partitioned by the stopper unit, the abutting member is inserted between the head container and the subsequent container which are separated by an interval created by the stopper unit and the containers can be propelled to the feed port in a stable manner by the abutting member.

According to the container supply device of the sixth aspect of the present invention, in addition to the effect produced by the container supply device according to the third aspect of the present invention, due to the containers are arranged by being lined up so as to be movable in a column direction in the container mounting lane unit, the plurality of container mounting lane units and the containers arranged in the matrix pattern are sequentially fed from the container storage toward the supply position by the transfer mechanism and the feed mechanism.

According to the container supply device of the seventh aspect of the present invention, in addition to the effect produced by the container supply device according to any one of the one to sixth aspects of the present invention, due to the container supply device further including: a container detecting unit which detects the containers arranged in the container mounting lane units; and a controller which controls a transport actuator of the lane transfer unit in accordance with a detection signal of the container detecting unit, since containers are sequentially fed to the feed port from a container mounting lane unit in which a container has been detected by the container detecting unit, on which container mounting lane unit the containers are mounted can be comprehended and the containers can be reliably fed from the container mounting lane unit on which the containers are mounted to the feed port and, consequently, accommodation work of the containers can be simplified.

### BRIEF DESCRIPTION OF DRAWINGS

FIG. 1 is a perspective view showing an automatic beverage provision system incorporating a container supply device representing an embodiment of the present invention.

FIG. 2 is a perspective view showing a state where a drawer unit of the container supply device has been withdrawn.

FIG. 3 is a perspective view showing the container supply device in a state where there are no more containers in a plurality of container mounting lane units.

FIG. 4 is a front view of the container supply device shown in FIG. 3.

FIG. 5 is a side view of the container supply device shown in FIG. 3.

FIG. 6 is a diagram for explaining a relationship among various dimensions of the container supply device.

FIG. 7 is a block diagram showing a control configuration of the container supply device.

FIG. 8A to FIG. 8F are explanatory operation diagrams of the container supply device.

### DESCRIPTION OF EMBODIMENTS

As long as a container supply device according to the present invention supplies containers to a supply position from a container storage where the containers are stored and the container supply device includes: a transfer mechanism which transfers the containers to a feed position opposing a feed port of the containers of the container storage; and a feed mechanism which sequentially feeds the containers having been transferred to the feed position by the transfer mechanism toward the supply position through the feed port, the transfer mechanism including: a plurality of container mounting lane units in which the containers are arranged by being lined up so as to be movable in a column direction, the plurality of container mounting lane units being arranged so as to be lined up in a row direction intersecting the column direction; and a lane transfer unit which moves the plurality of container mounting lane units in the row direction and transfers the containers on a side of the feed port mounted on the container mounting lane units to the feed position, specific embodiments of the container supply device may be of any form.

In addition, besides being used as a stand-alone device, the container supply device according to the present invention may be incorporated into various systems such as an automatic beverage provision system which automatically provides a beverage in accordance with an order placed by a customer or incorporated into a system which automatically provides cooking in accordance with an order placed by a customer to supply containers on which the cooking is to be arranged.

To this end, the containers supplied by the container supply device according to the present invention may be a beverage container such as a tumbler with a hollow heat-insulated structure made of stainless steel or a glass or a mug made of glass, a container for food other than beverages such as various kinds of cooking, soups, parfaits, and ice cream, or a container which accommodates articles other than food. Furthermore, various materials such as glass, ceramics, and metal may be applied as the material of the container.

### Embodiment

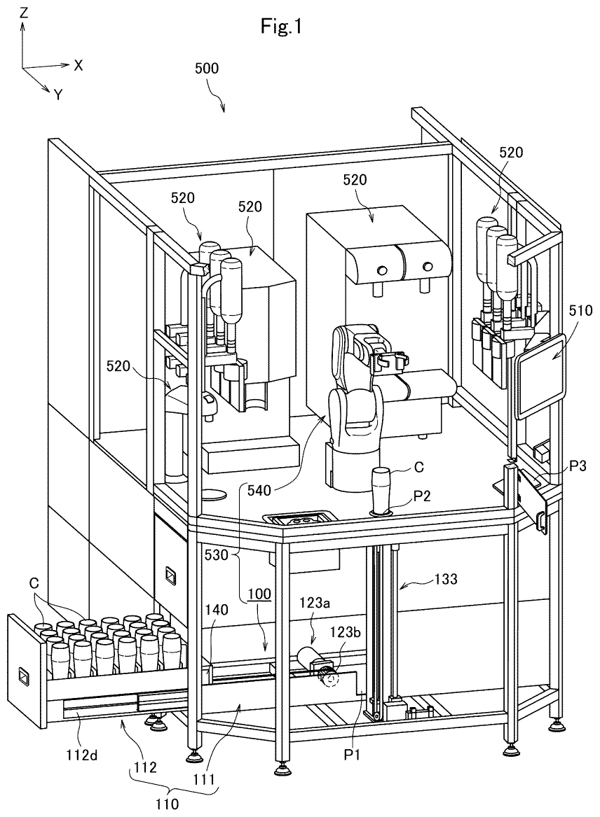

Hereinafter, an embodiment related to the container supply device according to the present invention will be described based on FIGS. 1 to 7.

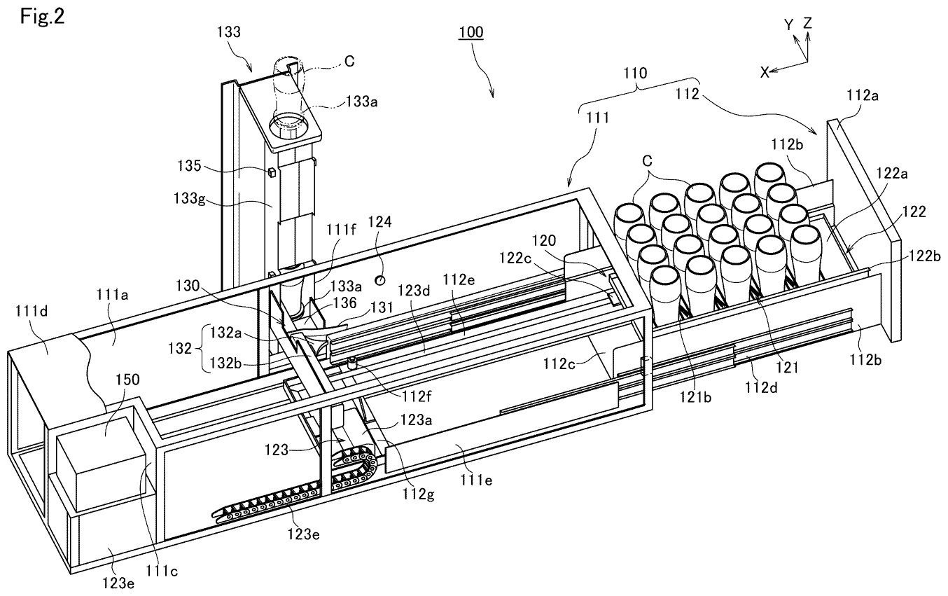

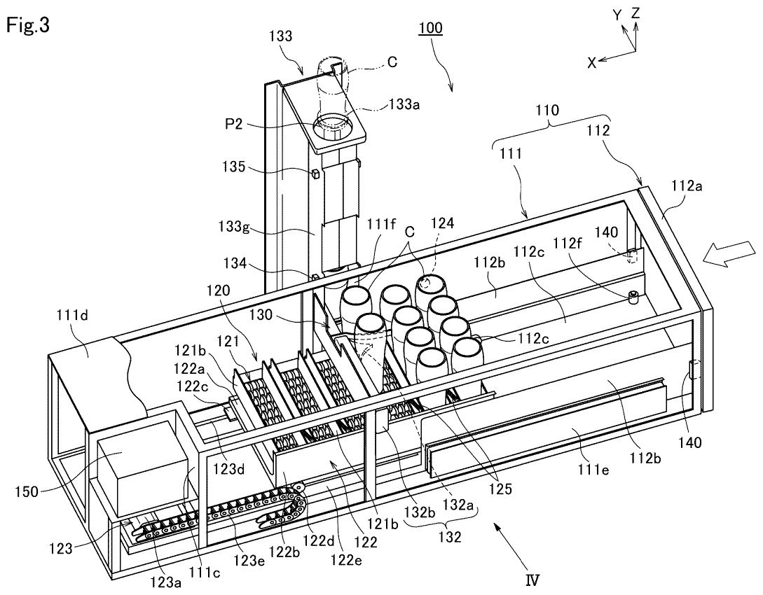

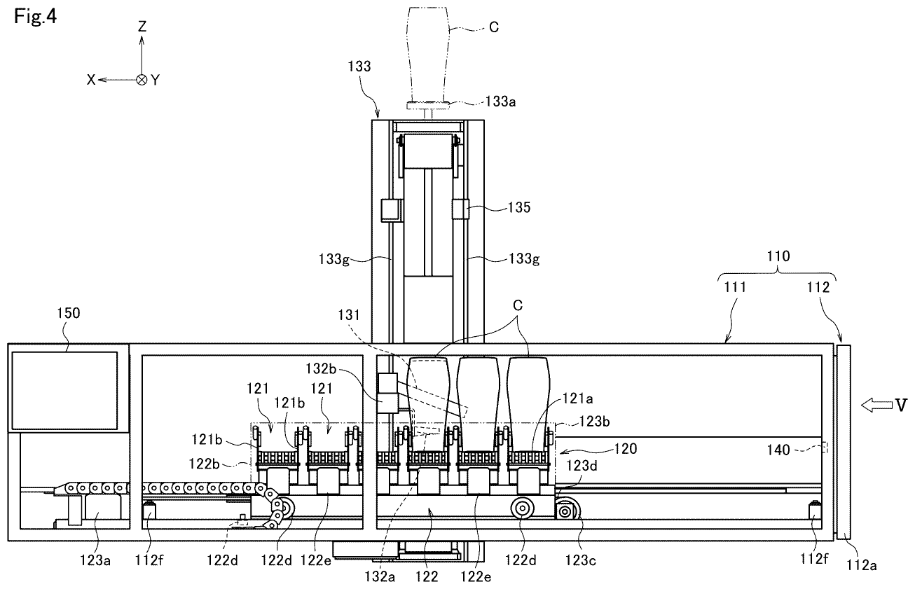

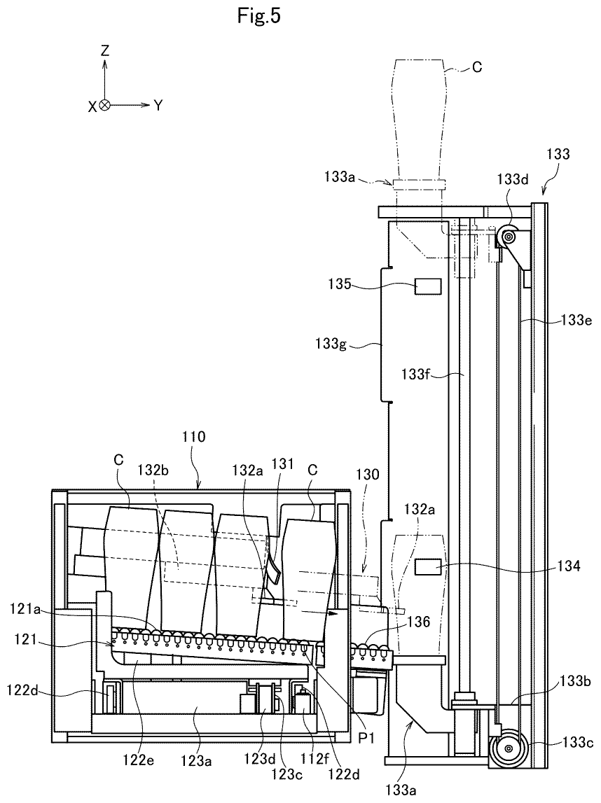

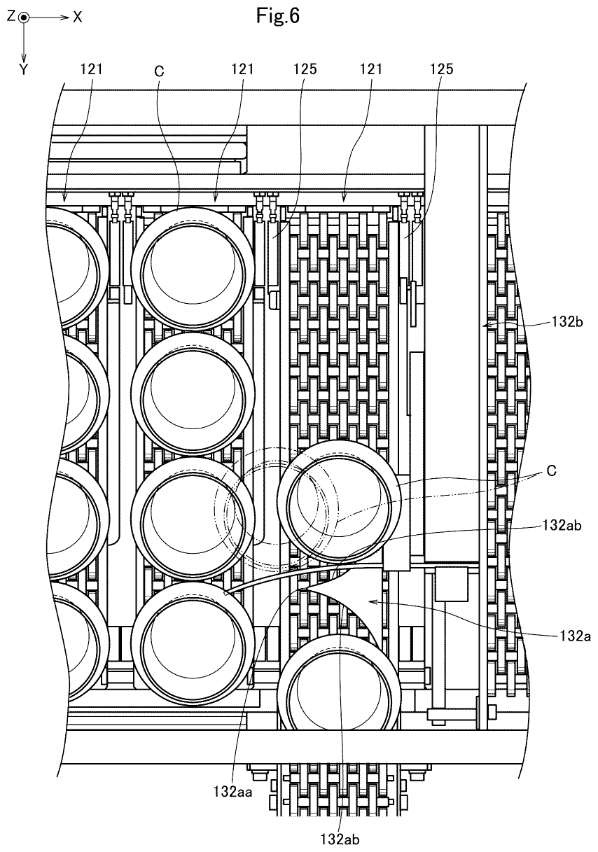

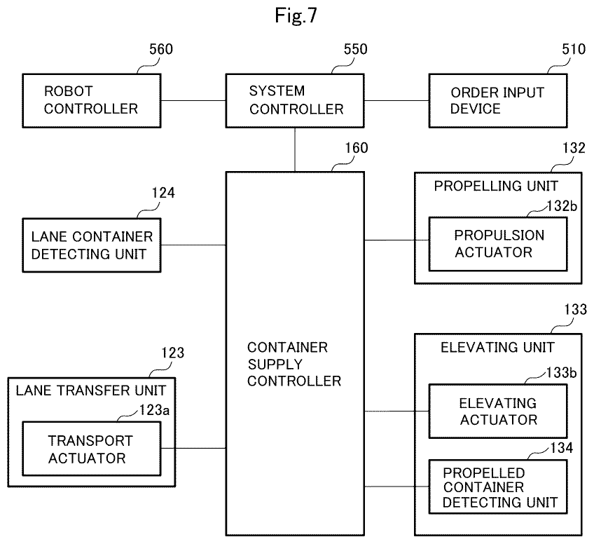

FIG. 1 is a perspective view showing an outline of an automatic beverage provision system 500 incorporating a container supply device 100 which represents an embodiment of the present invention. FIG. 2 is a perspective view showing an outline of a state where a drawer unit 112 of the container supply device 100 has been withdrawn. FIG. 3 is a perspective view showing an outline of an operating condition of the container supply device 100. FIG. 4 is a front view of the container supply device 100 shown in FIG. 3. FIG. 5 is a side view of the container supply device 100 shown in FIG. 3. FIG. 6 is a diagram for explaining a relationship among various dimensions of the container supply device 100. FIG. 7 is a block diagram showing a control configuration of the container supply device 100.

Note that in FIGS. 2 to 5, a front side and an upper surface wall in the diagrams of a container storage 110 are made transparent in order to make an interior visible.

In addition, in FIG. 2, in order to show a lane mounting bottom wall 122a of a lane mounting tray unit 122, one of six container mounting lane units 121 has been omitted.

<Overview of Automatic Beverage Provision System 500 Incorporating Container Supply Device 100>

First, an overview of the automatic beverage provision system 500 which incorporates the container supply device 100 will be explained.

As shown in FIG. 1, the automatic beverage provision system 500 is provided with an order input device 510 which accepts an order for a beverage, beverage supply devices 520 including a beer server, a soda server, an ice dispenser, a shot measurer, and a water server which supply beverages, and a container conveying device 530 which moves a container C for the beverage to a supply position P2 of the beverage by the beverage supply device 520, and the automatic beverage provision system 500 automatically provides a beverage in accordance with the order accepted by the order input device 510.

The container conveying device 530 is constituted of a robot arm 540 and the container supply device 100.

The container supply device 100 is incorporated into a lower part of the automatic beverage provision system 500, accommodates the containers C in an externally withdrawable drawer unit 112 in which a plurality of containers C are accommodated, and sequentially feeds the containers C accommodated inside the container supply device 100 to the supply position P2 above where a hand unit of the robot arm 540 grasps the containers. Since the container supply device 100 is incorporated into the lower part of the automatic beverage provision system 500, a storage space for the containers C can be secured below the robot arm 540 and, therefore, a storage space for the containers C can be sufficiently secured. In addition, when an interior of a container storage 110 is to be cooled by a temperature regulating mechanism 150, the containers C can be stored in a state of being cooled to a desired temperature, and since the container storage 110 is positioned below the robot arm, cooling efficiency can be enhanced by taking advantage of the fact that cold air stays below.

The hand unit of the robot arm 540 grasps the container C supplied to the supply position P2 by the container supply device 100. The container C is moved to the beverage supply device 520 by the hand unit of the robot arm 540 and after a beverage in accordance with the order is supplied into the container C, the container C filled with the beverage is provided at a provision position P3 to the customer.

<Specific configuration of container supply device 100>

A specific configuration of the container supply device 100 will be described using FIGS. 2 to 5.

The container supply device 100 includes the container storage 110 in which the containers C are stored, a transfer mechanism 120 which transfers the containers C to a feed position P1 opposing a feed port 111f of the containers C of the container storage 110, a feed mechanism 130 which sequentially feeds the containers C having been transferred to the feed position P1 by the transfer mechanism 120 toward the supply position P2 through the feed port 111f, a door lock mechanism 140 which locks a door 112a of the container storage 110, the temperature regulating mechanism 150 which regulates a temperature inside the container storage 110 to a desired temperature, and a container supply controller 160 which controls driving of each unit of the container supply device 100.

<Container storage 110>

The container storage 110 includes a storage main body unit 111 and the drawer unit 112 which is provided so as to be withdrawable with respect to the storage main body unit 111.

As shown in FIGS. 2 and 3, the storage main body unit 111 of the container storage 110 includes a pair of side walls 111a which are arranged so as to oppose each other with the lane mounting tray unit 122 therebetween and which extend in a row direction, a bottom wall 111b, a back wall 111c, and a top wall 111d, and a face opposing the back wall 111c is an open portion.

Note that in the present embodiment, an X axis direction shown in FIGS. 2 and 3 will be referred to as a “row direction”, a Y axis direction will be referred to as a “column direction”, and a Z axis direction will be referred to as a “height direction”.

The pair of side walls 111a is provided with slide guides 111e which guide a movement of the drawer unit 112 in a withdrawing direction.

In addition, the feed port 111f is provided at a position corresponding to an elevating unit 133 of the side wall 111a on a side of a positive Y axis direction among the pair of side walls 111a.

The feed port 111f is provided at a position on a side of a positive X axis direction of an end on the side of the positive X axis direction of a side plate 112b on the side of the positive Y axis direction of the drawer unit 112 in a state where the drawer unit 112 is accommodated in the storage main body unit 111.

The drawer unit 112 of the container storage 110 is provided with the door 112a for closing the opening portion of the storage main body unit 111, a pair of side plates 112b, a bottom plate 112c, a pair of slid guides 112d, a guide rail 112e which guides a movement in the row direction of the lane mounting tray unit 122, a stopper 112f which restricts both end positions of a movement range in the row direction of the lane mounting tray unit 122, and a drive unit mounting table 112g on which a transport actuator 123a of the transfer mechanism 120 is to be mounted.

The pair of slid guides 112d is slidably engaged with the pair of slide guides 111e provided on the pair of side walls 111a of the storage main body unit 111.

The drawer unit 112 can be smoothly withdrawn with respect to the storage main body unit 111 via the pair of slid guides 112d.

The guide rail 112e is a rail which guides a guide roller 122d provided in the lane mounting tray unit 122 and which is provided along the row direction on the bottom plate 112c so as to correspond to the movement range in the row direction of the lane mounting tray unit 122.

The drive unit mounting table 112g is connected to a terminal of the guide rail 112e. Therefore, by arranging the transport actuator 123a on a side of the terminal of the guide rail 112e, a drive belt 123d can be stretched from a drive roller 123b in a periphery of the terminal of the guide rail 112e to a driven roller 123c.

Accordingly, the lane mounting tray unit 122 is driven in the X direction along the guide rail 112e by the drive belt 123d.

<Transfer Mechanism 120 of Container Supply Device 100>

The transfer mechanism 120 includes six container mounting lane units 121, the lane mounting tray unit 122, a lane transfer unit 123, and a lane container detecting unit 124 (refer to FIG. 2).

The containers C are arranged by being lined up so as to be movable in the column direction in the container mounting lane units 121 of the transfer mechanism 120, and the container mounting lane units 121 are arranged by being lined up in the row direction intersecting the column direction.

While an arrangement of the six container mounting lane units 121 lined up in the row direction has been exemplified in the present embodiment, the number of the container mounting lane units 121 is not limited to six and need only be a plurality.

Hereinafter, when describing the six container mounting lane units 121 by distinguishing the container mounting lane units 121 from one another, the container mounting lane units 121 will be referred to as a “first-column container mounting lane unit 121”, a “second-column container mounting lane unit 121”, . . . , a “sixth-column container mounting lane unit 121” in order from a far side in the container storage 110.

A plurality of conveying rollers 121a are provided on a mounting surface of the containers C of the container mounting lane unit 121 to enable the containers C to smoothly move on the conveying rollers 121a.

In addition, the container mounting lane unit 121 is provided with a pair of guide walls 121b which support the containers C mounted on the container mounting lane unit 121 from both sides in the X direction. The pair of guide walls 121b has a function of positioning the containers C in a width direction of the container mounting lane unit 121.

By providing the pair of guide walls 121b so that an interval therebetween is adjustable, the container mounting lane unit 121 can be adapted to containers C of different sizes.

In addition, while the containers C are not particularly limited, in the present embodiment, so-called tumblers are used as the containers C. The containers C have a hollow heat-insulated structure made of stainless steel and have an external shape of which a lower part is smoothly narrowed as compared to an upper part.

When the containers C are arranged by being lined up in proximity to each other, the containers C come into contact in their upper parts with a large diameter and gaps are created between the narrowed lower parts. A stopper unit 131 to be described later is designed so as to conform to the shape of the containers C described above and is provided so that a front end thereof is positioned in the gaps between the narrowed lower parts. In addition, an abutting member 132a is given an approximately triangular shape which fits with the shapes of the narrowed lower parts of two adjacent containers C.

In addition, as shown in FIG. 3, the lane mounting tray unit 122 of the transfer mechanism 120 is provided with a lane mounting bottom wall 122a on which the six container mounting lane units 121 are mounted, an erected wall 122b which is erected at one end of the lane mounting bottom wall 122a, a belt connector 122c which is connected to the drive belt 123d of the lane transfer unit 123 to be described later, and the guide roller 122d which guides a movement in the row direction of the lane mounting tray unit 122.

As shown in FIGS. 4 and 5, the lane mounting bottom wall 122a is provided with pedestals 122e on which each container mounting lane unit 121 is to be mounted, and by differentiating heights of the respective pedestals 122e which support an end on the side of the feed port 111f and an end on an opposite side of the container mounting lane unit 121, the container mounting lane unit 121 is to be mounted in an inclined state.

The erected wall 122b is a wall which is erected at one end on an opposite side to the side of the feed port 111f of the lane mounting bottom wall 122a and which restricts a movement of the containers C mounted on the container mounting lane unit 121 so that the containers C do not fall off from the one end.

Note that a wall is not provided on the side of the feed port 111f of the lane mounting bottom wall 122a and a movement in the positive Y axis direction of the containers C mounted on the container mounting lane unit 121 is restricted by the side plates 112b of the drawer unit 112.

In addition, the erected wall 122b of the lane mounting tray unit 122 and the pair of guide walls 121b of each container mounting lane unit 121 are connected by a connecting spring 125 (refer to FIGS. 3 and 4).

The container mounting lane unit 121 which is held with a slight play on the lane mounting tray unit 122 is made swingable on the lane mounting tray unit 122 using elasticity of the connecting spring 125.

The lane transfer unit 123 of the transfer mechanism 120 is made up of the transport actuator 123a which is realized by, for example, a drive motor, the drive roller 123b which is driven by the drive motor, the driven roller 123c, and the endless drive belt 123d which is stretched over the drive roller 123b and the driven roller 123c.

The transport actuator 123a is connected to the container supply controller 160 via a power line, a control line, or the like which is run through a cable carrier 123e.

The lane mounting tray unit 122 is configured to be moved in the row direction in conjunction with a rotation of the drive belt 123d of the lane transfer unit 123 by being connected to the drive belt 123d via the belt connector 122c.

Note that the lane transfer unit 123 of the transfer mechanism 120 is not limited to belt drive and another actuator such as an electric cylinder may be used.

In addition, the lane container detecting unit 124 of the transfer mechanism 120 is realized by, for example, a photoelectronic sensor.

The lane container detecting unit 124 is provided on the side walls 111a of the storage main body unit 111 and detects whether or not there are containers C on the container mounting lane unit 121 along the column direction of the container mounting lane unit 121 and, at the same time, outputs a detected signal to the container supply controller 160.

The lane container detecting unit 124 is provided at a position where the containers C on the container mounting lane unit 121 can be detected without interfering with the stopper unit 131.

More specifically, the lane container detecting unit 124 is provided at a position which opposes the containers C of the third-column container mounting lane unit 121 when the container mounting lane unit 121 at a fixed end position from the fixed end toward a front end of the stopper unit 131 is considered a first column.

<Feed Mechanism 130 of Container Supply Device 100>

The feed mechanism 130 includes the stopper unit 131 which guides movement and restricts movement of the containers C on the container mounting lane unit 121, a propelling unit 132 which propels the containers C on the container mounting lane unit 121 to the feed port 111f, an elevating unit 133 which raises and moves the containers C having been propelled to the feed position P1 by the propelling unit 132 toward the supply position P2 above, and a propelled container detecting unit 134.

The stopper unit 131 is an elongated plate-like member which is made of, for example, metal and which has a bent shape, which protrudes in the row direction in a top view, and which is provided so as to freely penetrate between the container C at a head of a column to be a side of the feed port 111f (positive Y axis direction) and the container C adjacent to the rear of the container C at the head of the column.

In the present embodiment, the stopper unit 131 is protruded in the row direction to such a degree that a front end part thereof reaches a part of the container mounting lane unit 121 in an adjacent column in addition to the first-column container mounting lane unit 121.

The stopper unit 131 has a curved shape in which a front end part is warped to the side of the feed port 111f with respect to the row direction in at least a top view.

In addition, as shown in FIG. 4, in order to avoid interference with the abutting member 132a, the stopper unit 131 is arranged in a vertical direction so that one end is fixed to a position separated upward by an interval from the abutting member 132a and a front end part is oriented obliquely downward.

Furthermore, since the stopper unit 131 is provided so that the front end is oriented obliquely downward, when the containers C are moved by the lane transfer unit 123 along the stopper unit 131 from the front end toward the fixed end of the stopper unit 131, the containers C change a contact position with the stopper unit 131 from below to above.

Moreover, a twist may be imparted to the stopper unit 131 so that a face opposing the containers C corresponds to a curved surface of the containers C.

In addition, when the containers C are tumblers, since the shape of the tumblers smoothly change from a lower portion with a small diameter to an upper portion with a large diameter, the stopper unit 131 may also be designed with a twisted shape which conforms to the curved surface of the tumblers.

Furthermore, the propelling unit 132 is provided with the abutting member 132a and a propulsion actuator 132b which moves the abutting member 132a and causes the abutting member 132a to abut the containers C and propel the containers C to the feed port 111f.

The abutting member 132a is provided at a position behind a front end position in the row direction of the stopper unit 131 and the abutting member 132a is moved so as to slide between an acceptance position of the container C and a propulsion position to the feed port 111f by the propulsion actuator 132b which is realized by, for example, an electric cylinder.

The abutting member 132a has an approximately triangular cross section in which a vertex portion 132aa is oriented in the row direction and two abutting surfaces 132ab which connect to the vertex portion 132aa are formed in an approximate arc shape.

In addition, as shown in FIG. 5, the elevating unit 133 is provided with an elevating table 133a on which the containers C are to be mounted, an elevating actuator 133b which is realized by, for example, a drive motor and which vertically moves the elevating table 133a, a drive roller 133c which is driven by a drive motor, a driven roller 133d, an endless drive belt 133e which is stretched across the drive roller 133c and the driven roller 133d, a guide support 133f which supports and guides a vertical movement of the elevating table 133a, and a guide wall unit 133g which encloses a lateral area of the elevating table 133a so as to prevent the containers C which are vertically moved in a state of being mounted on the elevating table 133a from falling off the elevating table 133a.

The elevating table 133a is connected to the drive belt 133e and slidably assembled along the guide support 133f.

The guide wall unit 133g also functions as a wall that separates the containers C and the elevating actuator 133b from each other and prevents water from penetrating into the elevating actuator 133b even in a state where the containers C are damp, a state where the containers C are wet, and a state where the containers C are frozen.

The elevating unit 133 enables containers C of various specifications to be transferred by having the elevating table 133a and the guide wall unit 133g adjusted to dimensions which enable containers C of various specifications to be handled.

More specifically, a size of a container elevating space in a top view is adjusted by replacing the elevating table 133a, adjusting an outer diameter of the elevating table 133a, or adjusting an arrangement of the guide wall unit 133g.

The propelled container detecting unit 134 is realized by, for example, a photoelectronic sensor and detects that the containers C have been propelled onto the elevating table 133a to be a propulsion completion position by the propelling unit 132 and outputs a detection signal to the container supply controller 160.

The propelled container detecting unit 134 is provided in a periphery of a lower end position in a movement direction of the elevating table 133a of the elevating unit 133 and detects that the containers C have been moved to the elevating table 133a by the feed mechanism 130.

In addition, the elevating unit 133 may be further provided with a propelled container detecting unit 135.

The propelled container detecting unit 135 is realized by, for example, a photoelectronic sensor in a similar manner to the propelled container detecting unit 134.

As will be described later, when the container storage 110 is provided on two levels, the propelled container detecting unit 135 detects that the containers C have been propelled onto the elevating table 133a to be a propulsion completion position by the propelling unit 132 having been provided so as to correspond to the upper-level container storage 110 and outputs a detection signal to the container supply controller 160.

Furthermore, the elevating table 133a is vertically moved in accordance with a timing of propulsion of the containers C between a lower propulsion completion position which corresponds to the first-level container storage 110 and an upper propulsion completion position which corresponds to the second-level container storage 110.

Note that a connecting conveying roller 136 is provided between the container mounting lane unit 121 of the transfer mechanism 120 and the elevating table 133a of the elevating unit 133 and the connecting conveying roller 136 ensures that the containers C are moved from the conveying roller 121a of the container mounting lane unit 121 to the elevating table 133a in a smooth manner.

<Door Lock Mechanism 140>

The door lock mechanism 140 locks the door 112a of the drawer unit 112 of the container storage 110 and is realized by, for example, an electromagnetic lock.

The door lock mechanism 140 is provided in a periphery of the opening portion of the storage main body unit 111 and, in response to an operation of the device, locks the door 112a in an operating mode and unlocks the door 112a in a maintenance mode.

<Temperature Regulating Mechanism 150>

The temperature regulating mechanism 150 adjusts a temperature inside the container storage 110 and, in the present embodiment, maintains the interior of the container storage 110 within a refrigerating temperature zone or a freezing temperature zone.

Note that the temperature regulating mechanism 150 is not limited to adjusting the temperature to a refrigerating temperature zone or a freezing temperature zone and may be configured to heat the containers C when providing hot beverages.

In addition, while the container supply device 100 according to the present embodiment including the temperature regulating mechanism 150 has been exemplified, the container supply device 100 need not include the temperature regulating mechanism 150.

<Setting Dimensions of Stopper Unit 131>

Setting various dimensions of the container supply device 100 will be described using FIG. 6.

Before the stopper unit 131 abuts the containers C, when a y coordinate of an end position in a negative Y axis direction of the container C at a head (first) position in the positive Y axis direction at a height of a front end of the stopper unit 131 is denoted by “y1”, a y coordinate of the front end of the stopper unit 131 is denoted by “s1”, and a y coordinate of an end in the positive Y axis direction of the second container C in the positive Y axis direction at the height of the front end of the stopper unit 131 is denoted by “y2”, the y coordinate s1 of the front end of the stopper unit 131 is set so as to satisfy

y1>s1>y2 (1).

Setting such a dimensional relationship causes the front end of the stopper unit 131 to be inserted into a gap between the first and second containers C without the front end of the stopper unit colliding with the containers.

In addition, let a y coordinate of the vertex portion 132aa of the abutting member 132a be denoted by “a1” and a y coordinate of an end in the positive y axis direction of the second container C at a same X coordinate as the vertex portion 132aa of the abutting member 132a and a same height as the vertex portion 132aa when the stopper unit 131 abuts the second container C be denoted by “t2”. When a y coordinate of an end in the negative Y axis direction at the same height as the vertex portion 132aa of the container C corresponding to y1 described above is denoted by “t1”, a y coordinate t of the vertex portion 132aa is set so as to satisfy

t1>a1>t2 (2).

Setting such a dimensional relationship causes, when the second container C in the positive Y axis direction is moved along the stopper unit 131, the container C having been moved to the position of the vertex portion 132aa of the abutting member 132a in the row direction to be arranged at a position separated by a distance from the vertex portion 132aa by the stopper unit 131. Therefore, the second container C in the positive Y axis direction can be moved to a movement end position while avoiding a collision with the vertex portion 132aa of the abutting member 132a. In addition, the first container C never collides with the vertex portion 132aa.

In other words, by tilting, twisting, or bending the shape of the stopper unit 131 in correspondence with the various shapes of the containers C so as to satisfy the dimensional relationships represented by expressions (1) and (2), the front end of the stopper unit 131 can be inserted into a gap between the first and second containers C without colliding with the containers C in accordance with a movement of the container mounting lane unit 121, and due to the second container C being smoothly pushed forward in the direction of the negative Y axis direction along the curved surface of the stopper unit 131, the first container C can be moved to the movement end position while preventing the second container C in the positive Y axis direction from colliding with the vertex portion 132aa of the abutting member 132a.

<Container Supply Controller 160>

For example, the container supply controller 160 is installed outside of the container storage 110.

As shown in FIG. 7, the container supply controller 160 is connected to respective units related to the operation of the container supply device 100 including the lane transfer unit 123 of the transfer mechanism 120, the respective actuators 132b and 133b of the propelling unit 132 and the elevating unit 133 of the feed mechanism 130, and various container detecting units 124, 134, and 135.

In addition, the container supply controller 160 is connected to a system controller 550 which comprehensively controls the entire automatic beverage provision system 500.

The system controller 550 is connected to a robot controller 560 which controls the order input device 510 and the robot arm 540 described above.

In the present embodiment, each of the actuators 123a, 132b, and 133b is provided with a driver and the container supply controller 160 is connected to each driver via a control line.

When order information is input by the order input device 510 of the automatic beverage provision system 500 described above, a supply command of the containers C is sent from the system controller 550 to the container supply controller 160. In addition, drive of each unit of the container supply device 100 is controlled by the container supply controller 160 and the containers C are supplied from the container storage 110 to the supply position P2 to the robot arm 540.

The container supply controller 160 controls the transport actuator 123a of the lane transfer unit 123 so as to transfer the container mounting lane units 121 on which the containers C have been detected by the lane container detecting unit 124 in order from the first column to the feed position P1 which opposes the feed port 111f.

In addition, after transferring the container mounting lane units 121 to the feed position P1 opposing the feed port 111f, the container supply controller 160 controls the propulsion actuator 132b of the propelling unit 132 so as to cause the abutting member 132a to abut the containers C and propel the containers C to the feed port 111f.

Furthermore, when the containers C are detected by the propelled container detecting unit 134, the container supply controller 160 controls the elevating actuator 133b so as to raise the elevating table 133a.

<Container Supply Operation of Container Supply Device 100>

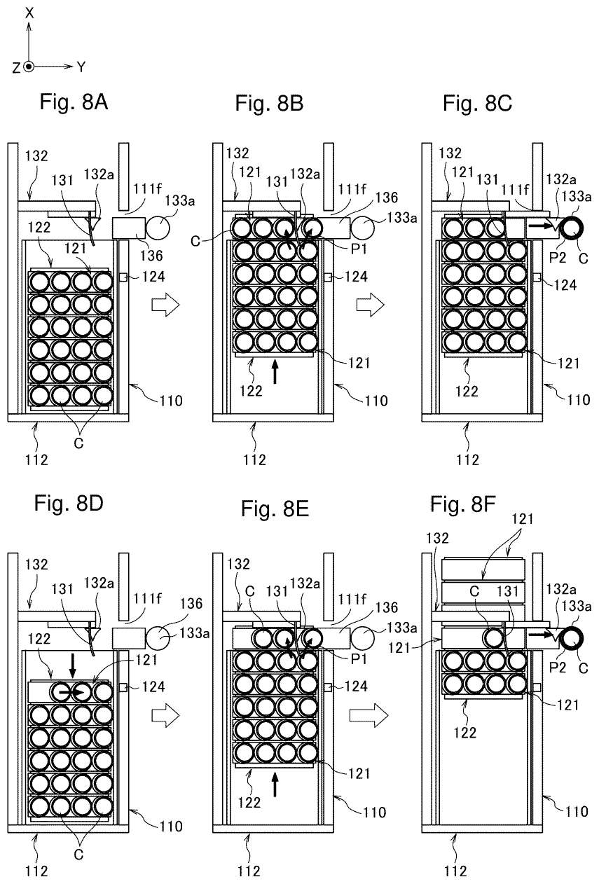

Next, an operation of the container supply device 100 of supplying containers C from the container storage 110 to the supply position P2 will be described using FIG. 8A to FIG. 8F.

As preliminary preparation for starting the operation of the container supply device 100, the containers C are accommodated inside the container storage 110.

When accommodating the containers C inside the container storage 110, the drawer unit 112 is withdrawn from the storage main body unit 111 and the containers C are mounted on each container mounting lane unit 121 in a state where upper surface sides of the six container mounting lane units 121 are externally exposed.

When withdrawing the drawer unit 112 from the storage main body unit 111, the drawer unit 112 is smoothly withdrawn via the slid guides 112d.

Therefore, by arranging the containers C with respect to the six container mounting lane units 121 having been collectively withdrawn by the drawer unit 112, a plurality of the containers C are arranged in a matrix pattern. At this point, since work to replenish the containers C to the container mounting lane units 121 can be performed from above the container mounting lane units 121 having been withdrawn outside, storage work can be readily performed while securing a sufficient work space.

Subsequently, by pushing the drawer unit 112 accommodating the containers C into the storage main body unit 111, the plurality of containers C arranged in the matrix pattern are arranged at predetermined push completion positions inside the container storage 110.

In a push completion state of the drawer unit 112, for example, as shown in FIG. 8A, the first-column container mounting lane unit 121 is arranged so as to assume a detection position of the containers C by the lane container detecting unit 124.

Note that the push completion state of the drawer unit 112 is not limited to a state where the first-column container mounting lane unit 121 is arranged at the detection position of the containers C by the lane container detecting unit 124 and, where there is space in the row direction (X direction) in the storage main body unit 111, the first-column container mounting lane unit 121 may be arranged at a position which deviates in the negative X direction from the detection position of the containers C by the lane container detecting unit 124 in the row direction (X direction).

In other words, in the push completion state of the drawer unit 112, the lane container detecting unit 124 may be arranged between the first-column container mounting lane unit 121 and the feed port 111f in the row direction (X direction).

When an operation of the device is started in the push completion state of the drawer unit 112, a presence or an absence of containers C on the first-column container mounting lane unit 121 is detected by the lane container detecting unit 124, and when the containers C are detected, the container mounting lane units 121 are moved to and arranged at a row direction position corresponding to the feed position P1 of the containers C by the transfer mechanism 120 (refer to FIG. 8B).

At this point, the six container mounting lane units 121 are collectively moved in the row direction due to a movement in the row direction of the lane mounting tray unit 122.

Since the container mounting lane units 121 are inclined downward to the side of the feed port 111f, the containers C are moved toward the feed port 111f using their own weight.

In addition, at this point, due to the container mounting lane units 121 being moved in the row direction, the front end portion of the stopper unit 131 oriented obliquely downward penetrates into a gap between the head container C and an adjacent container C in a portion where a diameter of the containers C is small, and the container C adjacent to the rear having been abutted by the front end of the stopper unit 131 is moved along the stopper unit 131 so as to be separated from the container C at the head position of the column.

At this point, vibration caused by operation of the device is transmitted to the connecting spring 125 which connects the erected wall 122b of the lane mounting tray unit 122 and the pair of guide walls 121b of each container mounting lane unit 121, and due to the container mounting lane units 121 relatively swaying with respect to the lane mounting tray unit 122, movement of the containers C in the direction of the feed port 111f using the own weight of the containers C is promoted.

In this state, when order information is input to the order input device 510 of the automatic beverage provision system 500, a supply command of the containers C is sent from the system controller 550 to the container supply controller 160. When the container supply controller 160 receives the supply command of the containers C, an operation by the container supply device 100 of retrieving the containers C to the supply position P2 is started.

The container C at the head position of the column of the container mounting lane units 121 is moved to a position opposing the feed port 111f from a state where the container C abuts the side plate 112b of the drawer unit 112 by a movement using its own weight due to the incline of the container mounting lane units 121 and the container C is then transferred toward the feed port 111f using its own weight. At this point, the container C at the head position of the column is moved to a position where the container C is partially mounted to the connecting conveying roller 136 due to its own weight.

In addition, the stopper unit 131 is arranged between the container C at the head position of the column to be a side of the feed port 111f and the container C adjacent to the rear of the container C at the head position due to a movement of the lane mounting tray unit 122 in the row direction without using a drive mechanism and a movement of the rear container C in an inclined direction is prevented.

In this manner, the second container C on the side of the feed port 111f is moved to a position separated by an interval from the head container C without colliding with the vertex portion 132aa of the abutting member 132a.

Subsequently, the head container C of the column is propelled to the feed port 111f by the propelling unit 132 of the feed mechanism 130 (refer to FIG. 8C).

At this point, when the propelled container detecting unit 134 detects that the container C propelled to the feed port 111f has been propelled to the feed port 111f, the container C is moved to the supply position P2 due to the elevating actuator 133b raising and moving the elevating table 133a.

When the propelled container detecting unit 134 does not detect that the container C has been propelled to the feed port 111f, a determination is made that an abnormality has occurred in the transfer mechanism 120 or the feed mechanism 130 and the abnormality is announced by, for example, display on a touch panel of the order input device 510 or the like, by sound, or the like.

Alternatively, a propulsion operation of the container C from the container mounting lane unit 121 on which the container C had been detected to the feed port 111f is executed once again.

Subsequently, the container C propelled to the feed port 111f is raised and moved to the supply position P2 by the elevating unit 133.

As a result, based on a drive signal indicating that the elevation and movement of the elevating table 133a have been completed, the system controller 550 which comprehensively controls the automatic beverage provision system 500 described above transmits, to the robot controller 560, a signal for starting a movement of the container C supplied to the supply position P2 by the robot arm 540. In this manner, subsequent operations until a beverage is provided by the robot arm 540 are performed.

Subsequently, the container mounting lane unit 121 at a position corresponding to the feed position P1 of the containers C is returned to the detection position of the containers C by the lane container detecting unit 124 and a presence or an absence of containers C in the first-column container mounting lane unit 121 is detected by the lane container detecting unit 124 (refer to FIG. 8D).

When the container mounting lane unit 121 is returned to the detection position of the containers C by the lane container detecting unit 124, the container C on the lane container detecting unit 124 deviates from a restricted position by the stopper unit 131. As a result, the rear container C of the column of which a movement in an inclined direction has been prevented by the stopper unit 131 is moved in the inclined direction, abuts the side plate 112b of the drawer unit 112, and stops.

When the container C abuts the side plate 112b of the drawer unit 112 and stops in this manner, the container C is moved along the curved surface of the stopper unit 131 so as to gradually reduce a distance to the side plate 112b of the drawer unit 112.

Subsequently, when the presence of containers C on the first-column container mounting lane unit 121 is detected by the lane container detecting unit 124, the container mounting lane units 121 are moved to and arranged at a position corresponding to the feed position P1 of the containers C by the transfer mechanism 120 and the feed operation of the containers to the feed port 111f described above is repeated (refer to FIG. 8E).

On the other hand, when the containers C of the first-column container mounting lane unit 121 is not detected by the lane container detecting unit 124, the container mounting lane units 121 from the second column to the sixth column are sequentially moved to the detection position of the containers C by the lane container detecting unit 124 and the operation described above is performed (refer to FIG. 8F).

The detection of the containers C of each container mounting lane unit 121 by the lane container detecting unit 124 is performed every time before moving the container mounting lane units 121 to the feed position P1 of the containers C in order to retrieve the containers C. Since the lane container detecting unit 124 need only determine whether or not the containers C are present in the container mounting lane unit 121 at the detection position, the lane container detecting unit 124 can be realized by a simple photosensor.

### <Effect Produced by Container Supply Device 100>

According to the container supply device 100 which is the embodiment of the present invention described above, due to the container supply device 100 including: the transfer mechanism 120 which transfers the containers C to the feed position P1 opposing the feed port 111f of the containers C of the container storage 110; and the feed mechanism 130 which sequentially feeds the containers C having been transferred to the feed position P1 by the transfer mechanism 120 toward the supply position P2 through the feed port 111f, the transfer mechanism 120 including: when a feed direction of the containers C toward the feed port 111f by the feed mechanism 130 is considered a column direction, six container mounting lane units 121 in which the containers C are arranged by being lined up so as to be movable in the column direction, the six container mounting lane units 121 being arranged so as to be lined up in the row direction intersecting the column direction; and the lane transfer unit 123 which moves the six container mounting lane units 121 in a row direction and transfers the container C at a head of a column to be a side of the feed port 111f of the container mounting lane units 121 to the feed position P1, since the containers C are arranged in a matrix pattern by being lined up and arranged on the six container mounting lane units 121 and the containers C arranged in the matrix pattern are sequentially fed from the container storage 110 toward the supply position P2 by the transfer mechanism 120 and the feed mechanism 130, six containers C can be accommodated with high accommodation efficiency in the matrix pattern, and since withdrawing the six container mounting lane units 121 from the container storage 110 to outside enables work efficiency of accommodating the containers C to be improved, accommodation efficiency of the containers C can be improved and work efficiency of accommodating the containers C can be improved and, consequently, the containers C can be readily sequentially extracted.

In addition, due to the transfer mechanism 120 including the lane mounting tray unit 122 on which the six container mounting lane units 121 are mounted with the side of the feed port 111f being inclined downward and which is moved in the row direction by the lane transfer unit 123, since the containers C are moved in the direction of the feed port 111f using their own weight and the six container mounting lane units 121 are collectively moved in the row direction due to the movement of the lane mounting tray unit 122 in the row direction, transfer of the containers C from the container storage 110 to the supply position P2 can be partially performed without depending on a drive mechanism, and since the plurality of container mounting lane units 121 can be collectively moved in the row direction by the lane mounting tray unit 122 and the containers C can be moved on the container mounting lane units 121 using their own weight, the drive mechanism can be reduced.

Furthermore, due to the feed mechanism 130 including the stopper unit 131 which protrudes in the row direction in a top view and the stopper unit 131 being provided so as to freely penetrate between the container C at a head of a column to be a side of the feed port 111f and the container C adjacent to the rear of the container C at the head of the column due to a movement of the six container mounting lane units 121 in the row direction by the lane transfer unit 123, since the stopper unit 131 is arranged between the container C at a head position of the column to be a side of the feed port 111f and the container C adjacent to the rear of the container C at the head position and a movement of the rear container C in the incline direction is blocked due to a movement of the lane mounting tray unit 122 in the row direction without using a drive mechanism, even when the containers C are closely arranged in the column direction, the container C at the head of the column to be a side of the feed port 111f can be sequentially fed separately from subsequent containers C, and since the stopper unit 131 can be fixed, a mechanism for driving the stopper unit 131 is not required.

In addition, due to the stopper unit 131 having a curved shape in which a front end part is warped to the side of the feed port 111f with respect to the row direction in at least a top view, since the container C adjacent to the rear having abutted the front end of the stopper unit 131 is smoothly moved along the shape of the stopper unit 131 so as to increase a distance to the container C at the head position of the column due to a movement of the lane mounting tray unit 122 in the row direction, even when the containers C are closely arranged in the column direction, the containers C can be readily fed to the side of the feed port 111f. Furthermore, by tilting, twisting, or bending the shape of the stopper unit 131 in correspondence with the various shapes of the containers C so as to satisfy the dimensional relationships represented by expressions (1) and (2), the front end of the stopper unit 131 can be inserted into a gap between the first and second containers C without colliding with the containers C in accordance with a movement of the container mounting lane unit 121, and due to the second container C being smoothly pushed forward in the direction of the negative Y axis direction along the curved surface of the stopper unit 131, the first container C can be moved to a movement end position while preventing the second container C in the positive Y axis direction from colliding with the vertex portion 132aa of the abutting member 132a. Moreover, by designing the stopper unit 131 in a shape that twists along the curved surface of the containers C, the stopper unit 131 is enabled to abut the container C more smoothly.

In addition, due to the feed mechanism 130 including the propelling unit 132 which causes the abutting member 132a provided at a position behind a front end position in the row direction of the stopper unit 131 to abut the container C and which propels the container C to the feed port 111f, since containers C are abutted by the abutting member 132a and propelled to the feed port 111f in a state where the container C at a head position of a column to be an earlier feed object and a subsequent container C are partitioned by the stopper unit 131, the abutting member is inserted between the head container C and the subsequent container C which are separated by an interval created by the stopper unit 131 and the containers C can be propelled to the feed port 111f in a stable manner by the abutting member 132a.

Furthermore, due to the transfer mechanism 120 including the lane container detecting unit 124 which detects the containers C arranged in the container mounting lane units 121 and the container supply device 100 further including the container supply controller 160 which controls the transport actuator 123a of the lane transfer unit 123 so as to arrange the container mounting lane unit 121 in which the containers C have been detected by the lane container detecting unit 124 at a position in a row direction corresponding to the feed position P1, since containers C are sequentially fed to the feed port 111f from the container mounting lane unit 121 in which the containers C have been detected by the lane container detecting unit 124, on which container mounting lane unit 121 the containers C are mounted can be comprehended and the containers C can be reliably fed from the container mounting lane unit 121 on which the containers C have been mounted to the feed port 111f, the containers C can be fed to the feed port 111f even when the containers C are irregularly accommodated in the six container mounting lane units 121 and, consequently, accommodation work of the containers C can be simplified.

In addition, due to the lane mounting tray unit 122 provided so as to be withdrawable from a side of an end in the row direction with respect to the container storage 110, since the lane mounting tray unit 122 is taken outside and a plurality of containers C can be accommodated from above the lane mounting tray unit 122 when accommodating the plurality of containers C in the container storage 110, accommodation work of the containers C can be simplified.

Furthermore, due to further including the temperature regulating mechanism 150 which regulates a temperature inside the container storage 110, since the containers C are stored in the container storage 110 regulated to a desired temperature by the temperature regulating mechanism 150, the temperature of the containers C can be managed to become a temperature suitable for an article to be accommodated in a container C to be provided.

For example, while a configuration in which a plurality of the container mounting lane units 121 are mounted on the lane mounting tray unit 122 and the plurality of the container mounting lane units 121 are collectively moved in the row direction due to the lane mounting tray unit 122 being moved in the row direction has been exemplified in the embodiment described above, a configuration in which each container mounting lane unit 121 is independently moved in the row direction by the lane transfer unit 123 without using the lane mounting tray unit 122 may be adopted.

While a configuration including the drawer unit 112 on one level or, in other words, the container storage 110 on one level has been exemplified in the embodiment described above, a configuration including the container storage 110 provided on a plurality of levels such as two levels as shown in, for example, FIG. 1 may be adopted. When the container storage 110 is provided on a plurality of levels, containers C of a different type may be accommodated in each container storage 110 and the container C of a type in accordance with an order may be supplied.

When the container C of a different type is to be supplied from each container storage 110, a configuration in which an interval between a pair of opposing guide walls 121b which support the container C mounted on the container mounting lane unit 121 from both sides is automatically adjusted in accordance with a size of the container C may be adopted.

The embodiment described above simply exemplifies a container supply device for embodying the technical concepts of the present invention and is not intended to specify the present invention to the container supply device and the like. The present invention can be equally applied to other embodiments created by modifying the embodiment, combining the elements of the embodiment, and the like.

1. A container supply device which supplies containers to a supply position from a container storage where the containers are stored, the container supply device comprising:
a transfer mechanism which transfers the containers to a feed position opposing a feed port of the containers of the container storage; and a feed mechanism which sequentially feeds the containers having been transferred to the feed position by the transfer mechanism toward the supply position through the feed port, wherein
the transfer mechanism includes:
one or more container mounting lane unit in which the containers are arranged so as to be movable in a column direction, the container mounting lane unit being arranged so as to be lined up in a row direction intersecting the column direction; and
a lane transfer unit which moves the container mounting lane unit in the row direction and transfers the containers on a side of the feed port mounted on the container mounting lane unit to the feed position.

2. The container supply device according to claim 1, wherein
the transfer mechanism includes a lane mounting tray unit which is moved in the row direction by the lane transfer unit, and
the container mounting lane unit is mounted on the lane mounting tray unit with a side of the feed port inclined downward.

3. The container supply device according to claim 2, wherein
the feed mechanism includes a stopper unit which protrudes in the row direction in a top view, and
the stopper unit is provided so as to freely penetrate between a container to be a side of the feed port and a container adjacent to the rear of the container to be a side of the feed port due to a movement of the container mounting lane unit in the row direction by the lane transfer unit.

4. The container supply device according to claim 3, wherein
the stopper unit has a curved shape in which a front end part faces the side of the feed port with respect to the row direction in a top view.

5. The container supply device according to claim 3, wherein
the feed mechanism includes an abutting member which is movable in the column direction at a position behind a front end position in the row direction of the stopper unit, and
the abutting member abuts the container and propels the container to the feed port.

6. The container supply device according to claim 1, wherein
the containers are arranged by being lined up so as to be movable in a column direction in the container mounting lane unit.

7. The container supply device according to claim 1, further comprising:
a container detecting unit which detects the containers arranged in the container mounting lane unit; and
a controller which controls a transport actuator of the lane transfer unit in accordance with a detection signal of the container detecting unit.
